(19) United States
(12) Patent Application Publication
(10) Pub. No.: US 2025/0034495 A1
(43) Pub. Date: Jan. 30, 2025

(54) METHOD OF REMOVING ALCOHOL FROM FERMENTED BEVERAGES WHILE PRESERVING THE FLAVOR PROFILE

(71) Applicant: Smartflow Technologies, Inc., Sanford, NC (US)

(72) Inventors: Jason BELL, Sanford, NC (US); Kelly Johnson, Sanford, NC (US); Todd Benson, Sanford, NC (US); Thomas Voboril, Sanford, NC (US); Marc Pugh, Sanford, NC (US)

(21) Appl. No.: 18/782,368

(22) Filed: Jul. 24, 2024

Related U.S. Application Data
(60) Provisional application No. 63/515,958, filed on Jul. 27, 2023.

(51) Int. Cl. C12H 3/04; A23L 2/38; A23L 2/46; A23L 2/72; B01D 61/02; B01D 61/08; C12C 12/04; C12H 1/07; C12H 1/18

(52) U.S. Cl. CPC C12H 3/04; A23L 2/382; A23L 2/46; A23L 2/72; B01D 61/025; B01D 61/08; C12C 12/04; C12H 1/063; C12H 1/18; B01D 2311/06; B01D 2311/08; B01D 2315/10; B01D 2315/16

(57) ABSTRACT

A system for processing fermented beverages to produce alcohol-reduced or alcohol-free fermented beverages or concentrates, and a method of using same, wherein the alcohol-reduced or alcohol-free fermented beverages have the desirable characteristics of the non-processed fermented beverage including, but not limited to, the flavor, the mouthfeel, and aroma, and wherein the alcohol-reduced or alcohol-free fermented concentrates can be reconstituted for consumption elsewhere.

### CROSS-REFERENCE TO RELATED APPLICATIONS

This application claims priority to U.S. Provisional Patent Application No. 63/515,958 filed on Jul. 27, 2023 in the name of Jason Bell et al., and entitled “Method of Removing Alcohol from Fermented Beverages While Preserving the Flavor Profile,” which is hereby incorporated by reference herein in its entirety.

### FIELD

The present invention relates generally to the removal of alcohol from fermented beverages and more particularly to systems and processes for producing non-alcoholic or designer fermented beverages that retain the taste, aroma, flavor profile and mouthfeel of the non-processed fermented beverage.

### BACKGROUND

While low alcohol and non-alcoholic adult beverages have been around for many years, available low alcohol and non-alcoholic adult beverages have yet to provide satisfactory flavor profiles that can mimic or substitute for traditional alcoholic beverages.

Fermentation affects conversion of fermentable sugars in ethanol, and also results in formation of various new flavor compounds, including esters. At the same time, fermentation of beer removes most aldehydes, thereby preventing a worty flavor of the resulting beer. After fermentation, the beer may be filtered and/or stored in order to optimize appearance and taste.

At present, there are two main techniques for the preparation of beer having low or zero alcohol content; de-alcoholization of regular beer and the preparation of beer by restricted alcohol fermentation.

De-alcoholization of beer is performed on regularly brewed beer, and is designed to remove ethanol, while maintaining most of the flavor components. De-alcoholization may be achieved by for instance rectification, evaporation, or dialysis of regular beer. However, it is challenging to prevent flavor deprivation upon de-alcoholization of beer. Consequently, a drawback of de-alcoholized beer is a flat flavor. i.e., low in sensory odor and taste when consumed, which must be corrected by the artificial addition of flavor and aroma compounds in order to obtain a palatable product. It is however far from easy to obtain an agreeable taste by the addition of flavor after de-alcoholization due to the flavor of a beverage being the result of a complex and delicate balance between the constituents of the beverage, amongst others the quantity and type of various sugars, esters, and aldehydes. In addition, the presence of alcohol, particularly ethanol, suppresses some taste attributes, and enhances others. Therefore, the taste of regular (alcohol-containing) fermented beverage, particularly a beer or beer-like beverage, cannot simply be mimicked by introducing compounds responsible for flavor in identical quantities, in a non-alcohol beverage.

Low- or zero alcohol beer can also be prepared by restricted alcohol fermentation. Restricted alcohol fermentation is a process whereby wort is fermented under conditions where there is little or no ethanol formation. One restricted alcohol fermentation process is cold contact fermentation, wherein wort is fermented at low temperature and the yeast barely produces alcohol, while some flavor components such as esters are still produced. Disadvantageously, at low temperatures, the activity of yeast in degrading aldehydes responsible for the worty flavor is decreased. Consequently, low or zero alcohol beer produced using a cold contact process (or another restricted fermentation process) has the drawback of a relatively high aldehyde content, which imparts worty flavor to the low- or zero alcohol beer. In addition, such beers are generally relatively sweet, due to the presence of remaining fermentable sugars.

There continues to be a need for improved systems and processes to remove alcohol from beer and other fermented beverages to yield non-alcoholic or designer fermented beverages that retain the taste, aroma, flavor profile and mouthfeel of their alcohol-containing counterparts.

### SUMMARY

In a first aspect, system for processing a fermented beverage to an alcohol-reduced or alcohol-free fermented beverage or concentrate is described, said system comprising:
(a) at least one reverse osmosis (RO) device, wherein a clarified fermented beverage feed comprising alcohol is introduced thereto to separate a RO permeate fraction comprising water and alcohol from a RO retentate fraction comprising retained flavor and color compounds present in the clarified fermented beverage feed;
(b) at least one microorganism reduction device to remove microorganisms from the RO retentate fraction to produce a liquid that is sterile or otherwise has a substantially reduced bioburden, wherein the sterile liquid is a substantially solids-free fraction comprising retained flavor and color compounds;
(c) optionally an alcohol and water separation device, to separate the RO permeate fraction into a water fraction and an alcohol fraction;
(d) a source of water, wherein the source of water comprises the water fraction from the alcohol and water separation device and/or water from an alternative source, and wherein the source of water is available for diafiltration at the at least one RO device and/or for final formulation; and
(e) optionally, a final formulator for combining the sterile liquid with water and optionally carbon dioxide to produce an alcohol-reduced or alcohol-free fermented beverage.
   In some embodiments, the system further comprises at least one liquid-solid separation device to separate a non-clarified fermented beverage feed comprising alcohol into a first permeate comprising a clarified fermented beverage comprising alcohol and a first retentate comprising solids present in the non-clarified fermented beverage; and a hot pasteurization device, wherein at least a portion of the first retentate is introduced and subjected to a temperature for a time necessary to kill microorganisms to produce a pasteurized solid.

In another aspect, a method of processing a fermented beverage to produce an alcohol-reduced or alcohol-free fermented beverage or concentrate is described, said method comprising:
(a) separating a clarified fermented beverage feed comprising alcohol into a second permeate comprising water and alcohol and a second retentate comprising retained flavors and color compounds present in the clarified fermented beverage feed;
(b) reducing the microorganism count of the second retentate to produce a liquid that is sterile or otherwise has a substantially reduced bioburden, wherein the sterile liquid is the substantially solids-free fraction comprising retained flavor and color compounds; and
(c) optionally, formulating the alcohol-reduced or alcohol-free clarified fermented beverage by combining at least the sterile liquid with water and optionally carbon dioxide.
   In some embodiments, the method further comprises separating a non-clarified fermented beverage feed comprising alcohol into a first permeate comprising a clarified fermented beverage comprising alcohol and a first retentate comprising solids present in the non-clarified fermented beverage; heating at least a portion of the first retentate at a temperature and for a time necessary to kill microorganisms to produce a pasteurized solid; and formulating (A) the alcohol-reduced or alcohol-free non-clarified fermented beverage by combining at least the (i) sterile liquid, (ii) some, or all, of the pasteurized solid, (iii) water and (iv) optionally carbon dioxide, or (B) an alcohol-reduced or alcohol-free non-clarified fermented beverage concentrate by combining the (i) sterile liquid, (ii) some, or all, of the sterile solid, and (iii) optionally additional water.

### BRIEF DESCRIPTION OF THE FIGURES

FIG. 1. An embodiment of the system described herein that can be used to process a clarified fermented beverage.

FIG. 2. An embodiment of the system described herein that can be used to process a non-clarified or turbid fermented beverage.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having.” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising.” “consisting of” and “consisting essentially of,” the embodiments or elements presented herein, whether explicitly set forth or not.

As defined herein, “desirables” include, but are not limited to, bioactive species, flavor- and aroma-contributing components, and nutrients.

As defined herein, “sterile filtration” is synonymously referred to as “0.2 micron absolute” via dead-end filtration or bioburden reduction filtration. Sterile filtration is the removal of viable microorganisms from a solution. In some embodiments, the commercial sterile filters rated by the ASTM F 838.05, which demonstrate removal of a standard test organism Brevundimonas diminuta at minimum concentrations of 10⁷ cfu/cm², or the equivalent thereof, have been used to attain the desired sterility. “Bioburden reduction” is defined herein as a reduction of microorganisms in a solution, but not to the level achieved using sterile filtration. For the purposes of the instant application, the terms “sterile” and “reduced bioburden” are not intended to be used interchangeably. A common process in the arts is to subject a solution to bioburden reduction before sterile filtration so as to extend the life of a more expensive sterile filter. Choosing whether to reduce bioburden, sterilize filter, or both (reduce bioburden then sterile filter), is up to the manufacturer and depends on how they intend to present their product, as readily understood by the person skilled in the art. For example, some amount of microorganisms may be desired in the fermented beverage in which case the fermented beverage is subjected to bioburden reduction to remove the undesirable microorganisms while minimally harming the desired microorganisms.

As used herein, a “sterile liquid” is a liquid that underwent sterile filtration or otherwise has a substantially reduced bioburden.

For the purposes of the present disclosure, “alcohol” is intended to be synonymous with ethanol.

The term “alcohol-reduced fermented beverage,” as is used herein, refers to a fermented beverage having a reduced level of ethanol, when compared to a corresponding normal fermented beverage. For example, an alcohol-reduced fermented beverages preferably comprises less than 1 vol %, preferably less than 0.5% vol %, of ethanol as an alcohol. “Non-alcoholic beer” may contain less than 0.5 vol % ethanol in the USA and some European countries, but not more than 0.05 vol % in the UK.

The term “alcohol-free fermented beverage,” as is used herein, refers to a fermented beverage in which no ethanol is present, or in which less than 0.03 vol % is present. “Non-alcoholic beer” may contain less than 0.5 vol % ethanol in the USA and some European countries, but not more than 0.05 vol % in the UK.

The term “fermented beverage,” as is used herein, refers to a fermented beverage product that is produced by fermentation of, for example, crops and products thereof such as grains, rice, grapes and other fruits (e.g., apples, pears, blueberries), nuts and/or exudations from, e.g., agave, yucca and cactus. Fermented beverages include, but are not limited to, beer (e.g., lagers or ales), wine, ciders, or mead.

Many fermented beverages comprise sediments and other solids in the liquid. “Clarified” fermented beverages, as is used herein, corresponds to fermented beverages that have been clarified to substantially remove the sediments and other suspended solids from the liquid. As defined herein, “clarified” corresponds to a fermented beverage that (1) has gone through at least one solids-removal process including, but not limited to, gravimetric sedimentation, filtration, cold-crash, or centrifugation, and (2) the suspended solids have been substantially reduced from said fermented beverage. “Non-clarified” fermented beverages are those that have not been clarified. For example, some fermented beverages have undergone some amount of gravimetric sedimentation to remove larger suspended solids but will be considered non-clarified because they still have a significant quantity of suspended solids, as noticed by the cloudiness or opacity of the beer. It should also be appreciated by the person skilled in the art that both clarified and non-clarified fermented beverage comprise dissolved solids, which are not visually observed.

Fermented beverages comprise a complex balance of water, sugars (e.g., fructose, sucrose, glucose), esters, ketones, aldehydes, phenols, ethanol, and/or higher alcohols, depending on the specific fermented beverage. The compounds in a brown ale may be substantially the same as those identified in a lager, but the proportions of said compounds will be different, lending themselves to the uniqueness of each type of fermented beverage. In addition, fermented beverages can contain polysaccharides, pectin, polypeptides, amino acids, vitamins, minerals, lipids, enzymes, carotenoids, and/or other non-volatile compounds.

As defined herein, “substantially solids-free” corresponds to a solution comprising less than about 1 v/v % solids, or less than about 0.5 v/v % solids, or less than about 0.2 v/v % solids, or less than about 0.1 v/v % solids, based on the total volume of the solution. It should be understood that the solids include suspended as well as non-suspended solids as well as sugar solids and non-sugar solids.

“Substantially devoid” is defined herein to mean that less than 1 wt % of the indicated substance is in the solution. In some embodiments, “substantially devoid” means that less than 0.5 wt % of the indicated substance is in the solution. In some embodiments, “substantially devoid” means that less than 0.1 wt % of the indicated substance is in the solution. In some embodiments, “substantially devoid” means that less than 0.001 wt % of the indicated substance is in the solution.

As defined herein, “solids” that are separated in the stage 1 filter include, but are not limited to, yeast cells and fine grain particulates.

Traditionally, non-alcoholic fermented beverages, e.g., beer, are produced by one of two processes; de-alcoholization and avoiding or reducing the formation of alcohol during fermentation under conditions that minimize fermentative production of alcohol. Disadvantageously, the processes currently used in the prior art do not result in a final alcohol-reduced fermented beverage or alcohol-free fermented beverage that retains the taste, flavor profile and mouthfeel of the alcohol-containing fermented beverage equivalent. The presently described system and process aims to overcome these deficiencies, permitting the production of an alcohol-reduced fermented beverage or alcohol-free fermented beverage that substantially retains the taste, odor, flavor profile and mouthfeel of the non-processed fermented beverage. Advantageously, no additives have to be added to the final formulated alcohol-reduced fermented beverage or alcohol-free fermented beverage produced using the systems and processes described herein. Moreover, the fermented beverage products produced using the systems and processes described herein are sterile or have a reduced bioburden.

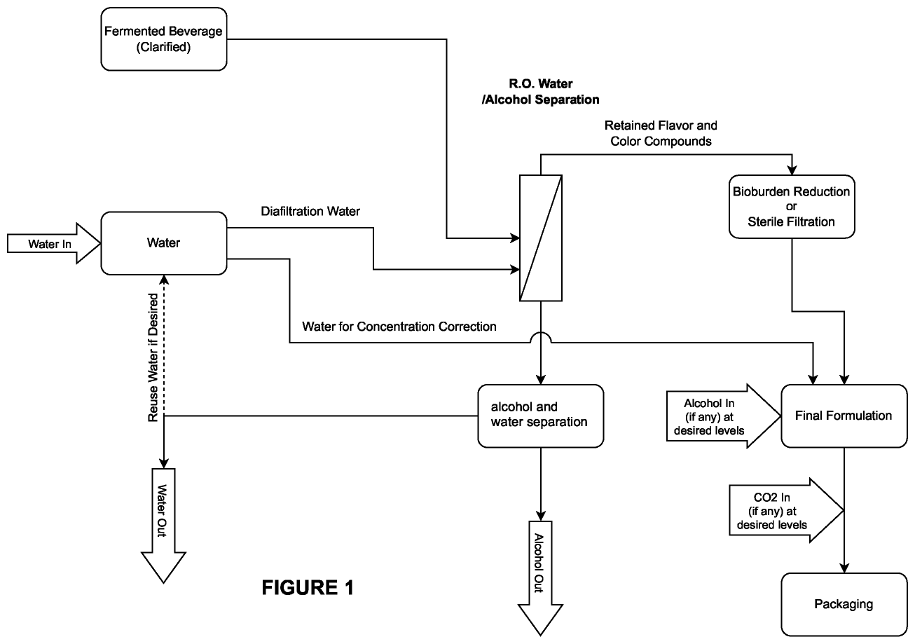

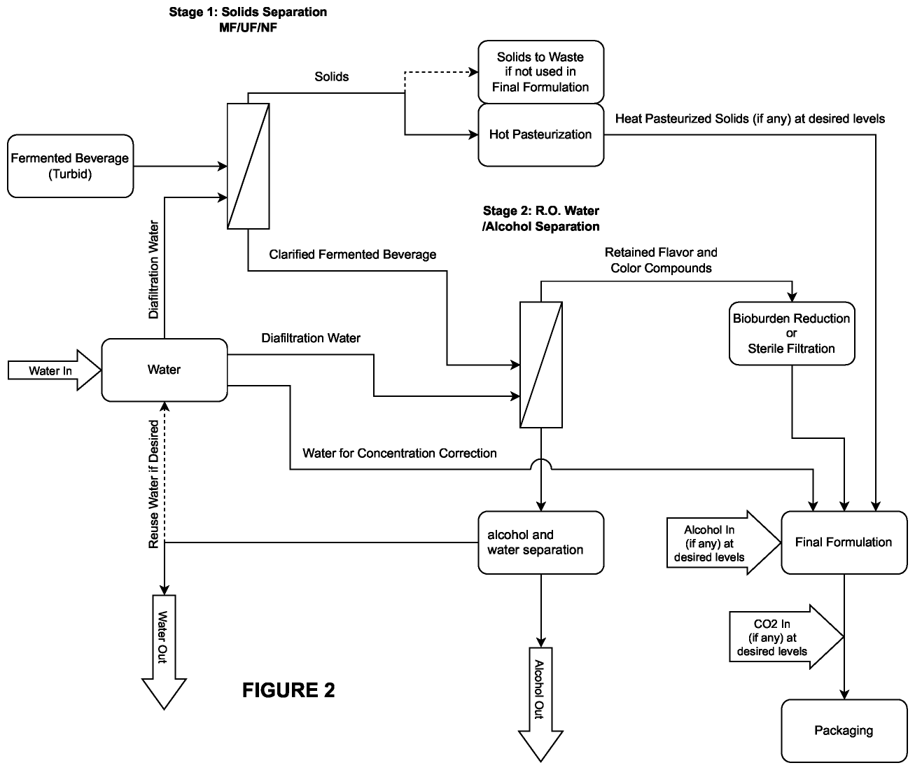

Broadly, the processing of a clarified fermented beverage (see, e.g., FIG. 1) includes (a) moving the clarified fermented beverage to at least one reverse osmosis (RO) device to obtain an RO permeate comprising water and alcohol and an RO retentate comprising retained flavor and color compounds; (b) moving the RO retentate to at least one microorganism reduction device to yield a “sterile liquid” which is sterile or otherwise has a substantially reduced bioburden; and (c) optionally separating the RO permeate using an alcohol and water separation device, e.g., a distillation device, to yield an alcohol fraction and a water fraction that can be reused as diafiltration water and/or water for concentration correction in the final formulation, to be discussed hereinafter. The processing of a non-clarified fermented beverage (see, e.g., FIG. 2) includes (a) separation of the solids from the fermented beverage using at least one liquid-solid separation device (e.g., dead-end filtration, centrifugation, tangential cross-flow filtration, reverse osmosis), optionally with diafiltration, to yield a permeate and a retentate, (b) (i) moving at least a portion, or all, of the solids in the retentate from the at least one liquid-solid separation device to a heating means (e.g., a heat pasteurizer) to kill microorganisms to produce a pasteurized solid fraction, and, when necessary, (ii) moving the unused portion of the solids to waste; (c) moving the permeate (i.e., clarified fermented beverage) from the at least one liquid-solid separation device to at least one reverse osmosis (RO) device to obtain an RO permeate comprising water and alcohol and an RO retentate comprising retained flavor and color compounds; (d) moving the RO retentate to a microorganism reducer to yield a “sterile liquid” which is sterile or otherwise has a substantially reduced bioburden; (e) optionally separating the RO permeate using an alcohol and water separation device, e.g., a distillation device, to yield an alcohol fraction and a water fraction that can be reused as diafiltration water and/or water for concentration correction in the final formulation, to be discussed hereinafter; and (f) optionally recombining/reblending the pasteurized solid fraction and the sterile liquid to produce a final formulation.

In some embodiments, the at least one liquid-solid separation device comprises a tangential cross-flow filtration device, e.g., as described herein. In some embodiments, the liquid-solid separation device consists of one cross-flow filtration device which includes diafiltration (see, e.g., FIG. 2) and can be processed continuously. Although not shown, in some embodiments, the liquid-solid separation device can comprise at least two cross-flow filtration devices, for example, a first cross-flow filtration device to produce a first permeate and a first retentate, optionally including diafiltration, followed by cross-flow filtration and diafiltration of the first retentate in a second cross-flow filtration device to produce a second permeate and a second retentate. The first and second permeates can be combined to produce a cumulative permeate, which is directed to the RO device, and the first and second retentates can be combined to produce a cumulative retentate, which is directed to hot pasteurization and/or waste (see, e.g., FIG. 2). Although not shown, in some embodiments, the at least one cross-flow filtration device comprises a recirculation loop wherein at least a portion of the retentate is reintroduced to the same cross-flow filtration device for additional processing. Following passage through the at least one liquid-solid separation device, substantially all of the desirables are in the permeate and the solids in the retentate. It should be understood by the person skilled in the art that the liquid-solid separation device can include one, two, three, four, or more cross-flow filtration devices, arranged in series, or some combination of two, three, four, or more separation devices selected from the group consisting of dead-end filtration, centrifugation, tangential cross-flow filtration, and reverse osmosis.

In some embodiments, the RO retentate is moved to at least one microorganism reduction device to produce a permeate comprising, consisting of, or consisting essentially of sterile liquid. The at least one microorganism reduction device includes a bioburden reduction device, a sterile filtration device, or a combination of a bioburden reduction device and a sterile filtration device, in that order. In some embodiments, the at least one microorganism reduction device (i.e., bioburden reduction device and/or sterile filtration device) never achieves a temperature greater than 30° C., maintaining the preservation of volatile flavor compounds and preventing other detrimental effects of heating on flavor. In some embodiments, the at least one microorganism reduction device (i.e., bioburden reduction device and/or sterile filtration device) never achieves a temperature above 25° C. In some embodiments, the at least one microorganism reduction device (i.e., bioburden reduction device and/or sterile filtration device) never achieves a temperature above 20° C. In some embodiments, the at least one microorganism reduction device (i.e., bioburden reduction device and/or sterile filtration device) never achieves a temperature above 15° C.

In some embodiments, an alcohol and water separation device, e.g., a distillation device, is included and used to separate the RO permeate to yield an alcohol fraction and a water fraction. Distillation devices are well known in the art. In some embodiments, the RO permeate is flow to a separate storage container or device for eventual separation of the water and ethanol. In embodiments where the water and alcohol separation device is separate from the rest of the described system, some water from an alternative source may be needed for diafiltration, etc., as understood by the person skilled in the art.

In some embodiments of the system and process of FIG. 1, the sterile liquid can be either (a) immediately packaged as a clarified fermented beverage concentrate for later reconstitution with at least water, optionally carbon dioxide, and optionally alcohol (at the desired percentages of alcohol), to produce a clarified fermented beverage for enjoyment, or (b) immediately packaged as an alcohol-reduced or alcohol-free clarified fermented beverage wherein the sterile liquid is combined with water, and optional carbonation, and packaged for later enjoyment. In some embodiments, the packaging is aseptic so as to eliminate the possibility of reintroducing microorganisms to the reformulated fermented beverage. In some embodiments, the clarified fermented beverage concentrate, is alcohol-reduced or alcohol-free, can be shipped within the state or country or internationally, including via interstate commerce because of the reduced alcohol content, and reconstituted, for example, at a drinking establishment, by adding at water and optionally carbonation. In some embodiments, upon reconstitution, in addition to water and carbonation, alcohol at the desired percentage can be readded to the clarified fermented beverage concentrate. For example, the percentage can correspond to the highest percentage permitted by law for the specific fermented beverage, or can be some lower value (e.g., 1%, 2%, 3%, etc.) so that the drinker can enjoy a clarified fermented beverage without running afoul of driving laws.

In some embodiments, a concentrate of the clarified fermented beverage comprises, consists of, or consists essentially of the permeate from the bioburden reduction or sterile filtration device or step (i.e., the sterile liquid). In some embodiments, the concentrate for the clarified fermented beverage further comprises added water.

In some embodiments of the system and process of FIG. 2, at least a portion, or all, of the pasteurized solid fraction and all of the sterile liquid can be reblended/recombined and either (a) packaged as a non-clarified fermented beverage concentrate for later reconstitution with at least water, optionally carbon dioxide, and optionally alcohol (at the desired percentages of alcohol), to produce a non-clarified fermented beverage for enjoyment, or (b) immediately packaged as an alcohol-reduced or alcohol-free non-clarified fermented beverage wherein at least a portion, or all, of the pasteurized solid fraction and all of the sterile liquid are combined with water, optional carbonation, and packaged for later enjoyment. Advantageously, strategic recombination ensures that the level of desired components is targeted to the final fermented beverage designer's preference, e.g., not all of the pasteurized solid fraction is recombined with the sterile liquid. In some embodiments, the packaging is aseptic so as to eliminate the possibility of reintroducing microorganisms to the reformulated fermented beverage. In some embodiments, the non-clarified fermented beverage concentrate, which is alcohol-reduced or alcohol-free, can be shipped within the state or country or internationally, including via interstate commerce because of the reduced alcohol content, and reconstituted, for example, at a drinking establishment, by adding at water and carbonation. In some embodiments, upon reconstitution, in addition to water and optional carbonation, alcohol at the desired percentage can be readded to the non-clarified fermented beverage concentrate. For example, the percentage can correspond to the highest percentage permitted by law for the specific fermented beverage, or can be some lower value (e.g., 1%, 2%, 3%, etc.) so that the drinker can enjoy a non-clarified fermented beverage without running afoul of driving laws.

In some embodiments, a concentrate of the non-clarified fermented beverage comprises, consists of, or consists essentially of the combination of the permeate from the bioburden reduction or sterile filtration device or step (i.e., the sterile liquid) and the pasteurized solid from the hot pasteurization device. In some embodiments, the concentrate for the non-clarified fermented beverage further comprises added water.

In some embodiments, water is recovered from the alcohol and water separation device, e.g., the distillation device, and reutilized in the system and process, for example, during diafiltration (i.e., during RO separation or at the at least one liquid-solid separation device) or if water is added during final formulation. In some embodiments, other than water needed at the time of process/system startup, the process/system is closed to the introduction of water not recovered during the process, meaning no additional water is added to the process/system during processing of the clarified or non-clarified fermented beverage and as such, other than system/method startup, the only source of water in the system/method is that found in the clarified or non-clarified fermented beverage. At system startup, some water is needed to for diafiltration during RO processing and at the least one liquid-solid separation device. Once the RO device is activated, RO permeate can thereafter be the only source of wash/rinse water in the system/process. That said, in some embodiments, in addition to the water needed at the time of process/system startup, some amount of additional water is added to the process/system during clarified or non-clarified fermented beverage production, as understood by the person skilled in the art.

An embodiment of the system and method described herein for clarified fermented beverages is shown in FIG. 1 and described below. For case of reference, the dashed lines between components indicate optional processing.
Reverse Osmosis device. The at least one RO device separates the clarified fermented beverage into a RO permeate comprising water and alcohol and an RO retentate comprising retained flavor and color compounds. Although not shown, two or more (e.g., 3, 4, 5, or more) RO devices can be arranged in parallel, as understood by the person skilled in the art. RO retentate from the at least one RO device can be bled off and moved to bioburden reduction/sterile filtration. RO permeate from the RO device can be directed to an alcohol and water separation device, e.g., a distillation device. In some embodiments, diafiltration water is introduced to the RO device, with the clarified fermented beverage, to assist with the separation by dilution. In some embodiments, diafiltration water is not needed and the RO device alone can separate the clarified fermented beverage into a RO permeate and an RO retentate. Whether just RO concentration, or RO concentration with diafiltration, the retained flavor and color compounds are substantially present in the RO retentate and water and ethanol are substantially present in the RO permeate. In some embodiments, there is no storage container for the RO permeate, and instead the RO permeate is communicatively connected to the alcohol and water separation device, e.g., a distillation device. In some embodiments, there is at least one storage container for the RO permeate (not shown), for example for storage prior to introduction to the alcohol and water separation device, e.g., a distillation device. In some embodiments, the alcohol and water separation device and method of separating water from alcohol are included so that the method/system remains closed to the introduction of water not recovered during the process, meaning little or no additional water is added to the method/system during processing of the clarified (or non-clarified) fermented beverage, as described herein. The intent of the at least one RO device is separate the retained flavor and color compounds from the water and alcohol so (a) only a small percentage of material has to be sent to bioburden reduction/sterile filtration, and (b) an alcohol-reduced or alcohol free fermented beverage (or concentrate) can be obtained.
Sterile or Bioburden Reduction Filtration (e.g., dead end membrane filter or equivalent thereof). The RO retentate comprising retained flavor and color compounds is then filter sterilized and/or undergoes bioburden reduction, as understood by the person skilled in the art, to produce a sterile liquid. The entire volume, less the removed microorganisms, permeates the sterile filter (and/or bioburden reduction filter) and passes to final formulation.
Final formulation. The sterile liquid is either (a) packaged as a clarified fermented beverage concentrate for later reconstitution with at least water, optionally carbon dioxide, optionally alcohol (at the desired percentages of alcohol), and optionally additional flavors (e.g., lime juice, clamato, etc.), to produce a clarified fermented beverage elsewhere for enjoyment or packaging (e.g., bottled or canned), or (b) packaged immediately as an alcohol-reduced or alcohol-free clarified fermented beverage, wherein the sterile liquid is combined with water, optionally carbon dioxide, and optionally additional flavors (e.g., lime juice, clamato, etc.), and packaged (e.g., bottled or canned) for transport and later enjoyment. In some embodiments, the packaging is aseptic so as to eliminate the possibility of reintroducing microorganisms to the reformulated fermented beverage. Packaging of the concentrate can include larger volume containers such as plastic jugs, bag in a box, etc.
Reuseable water. Water from the alcohol and water separator, e.g., a distillation device, can be recirculated and reused as diafiltration water or as water during final formulation.
Reuseable Alcohol. Alcohol from the alcohol and water separator, e.g., a distillation device, when included, is a distilled spirit and can be sold as ethanol for consumption or other uses such as fuel.

An embodiment of the system and method described herein for non-clarified fermented beverages is shown in FIG. 2 and described below. For ease of reference, the dashed lines between components indicate optional processing.
Filter Stage 1: The intent of the stage 1 filter is to separate a non-clarified fermented beverage into a (a) stage 1 permeate that is substantially free of suspended solids and thus can then be filter sterilized instead of heat pasteurized, thus permitting the stage 1 permeate to retain most of the flavor and aroma profile of the fermented beverage, and (b) a stage 1 retentate which comprises the solids from the non-clarified fermented beverage which can be heat pasteurized. Filter stage 1 comprises at least one of a microfiltration (MF) device, a nanofiltration (NF) device, an ultrafiltration (UF) device, or a RO device. In some embodiments, filter stage 1 comprises at least one MF/UF filtration device such as an open channel tangential cross-flow filtration cassette device as described hereinbelow. In some embodiments, the stage 1 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species. Although not shown, two or more (e.g., 3, 4, 5, or more) stage 1 filter devices can be arranged in parallel. The at least one stage 1 filter device retains sediment and suspended solids in the stage 1 retentate and a clarified fermented beverage that is substantially free of suspended solids in the stage 1 permeate. In some embodiments, a MF/UF Filter, ranging from 1 μm to 1 kDa, is used, as readily understood by the person skilled in the art, to separate solids from liquids. In some embodiments, diafiltration water is introduced to the stage 1 filter, with the initial non-clarified fermented beverage feed, to assist with the separation. In some embodiments, diafiltration water is not needed and the stage 1 filter alone can separate the non-clarified fermented beverage into a stage 1 permeate and a stage 1 retentate. Whether concentration alone, or concentration with diafiltration, the solids should be substantially present in the stage 1 retentate and the clarified fermented beverage should be substantially present in the stage 1 permeate. Although not shown, it should be appreciated that the Stage 1 filter can further comprise a recirculation loop wherein the stage 1 permeate and/or the stage 1 retentate is recirculated for reentry into the stage 1 filter. Following filtration, at least a portion, or all, of the stage 1 retentate can be moved to heat pasteurization. Because the system and process described herein permits for the engineering of a preferred non-clarified fermented beverage by adjusting the amount of pasteurized solids added to the sterile liquid at final formulation, not all of the stage 1 retentate has to be moved to heat pasteurization and as such, some may be moved to waste. The stage 1 permeate comprising the clarified fermented beverage is moved to the stage 2 reverse osmosis device for further separation.
Stage 2 Reverse Osmosis device. The intent of the at least one RO device is separate the stage 1 permeate into a stage 2 retentate (i.e., the retained flavor and color compounds) from the stage 2 permeate (i.e., water and alcohol) so (a) only a small percentage of material has to be sent to bioburden reduction/sterile filtration, and (b) an alcohol-reduced or alcohol free fermented beverage (or concentrate) can be obtained. The at least one RO device separates the clarified fermented beverage (i.e., the stage 1 permeate) into a RO permeate comprising water and alcohol and an RO retentate comprising retained flavor and color compounds. Although not shown, two or more (e.g., 3, 4, 5, or more) RO devices can be arranged in parallel, as understood by the person skilled in the art. In some embodiments, diafiltration water is introduced to the stage 2 RO device, with the stage 1 permeate, to assist with the separation by diluting the stage 1 permeate. In some embodiments, diafiltration water is not needed and the RO device alone can separate the clarified fermented beverage into a RO permeate and an RO retentate. Whether just RO concentration, or RO concentration with diafiltration, the retained flavor and color compounds are substantially present in the RO retentate and water and ethanol are substantially present in the RO permeate. RO retentate from the at least one RO device can be bled off and moved to bioburden reduction/sterile filtration. RO permeate from the RO device can be directed to alcohol and a water separation device, e.g., a distillation device. In some embodiments, there is no storage container for the RO permeate, and instead the RO permeate is communicatively connected to the alcohol and water separation device, e.g., a distillation device. In some embodiments, there is at least one storage container for the RO permeate (not shown), for example for storage prior to introduction to the alcohol and water separation device, e.g., a distillation device. In some embodiments, the alcohol and water separation device and method of separating water from alcohol are included so that the method/system remains closed to the introduction of water not recovered during the process, meaning little or no additional water is added to the method/system during processing of the non-clarified fermented beverage, as described herein.
Sterile or Bioburden Reduction Filtration (e.g., dead end membrane filter or equivalent thereof). The stage 2 RO retentate comprising retained flavor and color compounds is then filter sterilized and/or undergoes bioburden reduction, as understood by the person skilled in the art, to produce a sterile liquid. The entire volume, less the removed microorganisms, permeates the sterile filter (and/or bioburden reduction filter) and passes to final formulation.
Hot Pasteurization. In some embodiments, heat is used to pasteurize some, or all, of the stage 1 retentate to produce a pasteurized solid fraction, which can then be passed to final formulation. In some embodiments, very little of the liquid present in the initial non-clarified fermented beverage feed goes through the heat pasteurization process, thereby minimizing the impact of the heat on the desirables such as flavor and aroma quality. In some embodiments, less than 5% of the liquid present in the initial non-clarified fermented beverage feed goes through the heat pasteurization process using the system and method described herein. In other embodiments, less than 1% of the liquid present in the initial non-clarified fermented beverage feed goes through the heat pasteurization process using the system and method described herein. In still other embodiments, less than 0.5% of the liquid present in the initial non-clarified fermented beverage feed goes through the heat pasteurization process using the system and method described herein.
Final formulation. In some embodiments. (i) the sterile liquid and (ii) some, or all, of the pasteurized solid are recombined and then either (a) packaged as a non-clarified fermented beverage concentrate for later reconstitution with at least water, optionally carbon dioxide, optionally alcohol (at the desired percentages of alcohol), and optionally additional flavors (e.g., lime juice, clamato, etc.), to produce a non-clarified fermented beverage elsewhere for immediate enjoyment or packaging (e.g., bottled or canned), or (b) packaged immediately as an alcohol-reduced or alcohol-free non-clarified fermented beverage, wherein the sterile liquid/pasteurized solid concentrate is combined with water, optionally carbon dioxide, and optionally additional flavors (e.g., lime juice, clamato, etc.), and is packaged (e.g., bottled or canned) for transport and later enjoyment. In some embodiments, the packaging is aseptic so as to eliminate the possibility of reintroducing microorganisms to the reformulated fermented beverage. Packaging of the concentrate can include larger volume containers such as plastic jugs, bag in a box, etc.
Reuseable water. Water from the alcohol and water separator, e.g., a distillation device, can be recirculated and reused as diafiltration water or as water during final formulation.
Reuseable Alcohol. Alcohol from the alcohol and water separator, e.g., a distillation device, when included, is a distilled spirit and can be sold as ethanol for consumption or other uses such as fuel.

Accordingly, in a first aspect, a system for processing a fermented beverage to an alcohol-reduced or alcohol-free fermented beverage or concentrate is described, said system comprising:
(a) at least one reverse osmosis (RO) device, wherein a clarified fermented beverage feed comprising alcohol is introduced thereto to separate a RO permeate fraction comprising water and alcohol from a RO retentate fraction comprising retained flavor and color compounds present in the clarified fermented beverage feed;
(b) at least one microorganism reduction device to remove microorganisms from the RO retentate fraction to produce a liquid that is sterile or otherwise has a substantially reduced bioburden, wherein the sterile liquid is a substantially solids-free fraction comprising retained flavor and color compounds;
(c) optionally an alcohol and water separation device, to separate the RO permeate fraction into a water fraction and an alcohol fraction;
(d) a source of water, wherein the source of water comprises the water fraction from the alcohol and water separation device and/or water from an alternative source, and wherein the source of water is available for diafiltration at the at least one RO device and/or for final formulation; and
(e) optionally, a final formulator for combining the sterile liquid with water and optionally carbon dioxide to produce an alcohol-reduced or alcohol-free fermented beverage.

In some embodiments of the first aspect, the system for processing a clarified fermented beverage to an alcohol-reduced or alcohol-free clarified fermented beverage or concentrate comprises:
(a) at least one reverse osmosis (RO) device, wherein a clarified fermented beverage feed comprising alcohol is introduced thereto to separate a RO permeate fraction comprising water and alcohol from a RO retentate fraction comprising retained flavor and color compounds present in the clarified fermented beverage feed;
(b) at least one microorganism reduction device to remove microorganisms from the RO retentate fraction to produce a liquid that is sterile or otherwise has a substantially reduced bioburden, wherein the sterile liquid is a substantially solids-free fraction comprising retained flavor and color compounds;
(c) optionally an alcohol and water separation device, to separate the RO permeate fraction into a water fraction and an alcohol fraction;
(d) a source of water, wherein the source of water comprises the water fraction from the alcohol and water separation device and/or water from an alternative source, and wherein the source of water is available for diafiltration at the at least one RO device and/or for final formulation; and
(e) optionally, a final formulator for combining the sterile liquid with water and optionally carbon dioxide to produce an alcohol-reduced or alcohol-free clarified fermented beverage.

In some other embodiments of the first aspect, the system for processing a non-clarified fermented beverage to an alcohol-reduced or alcohol-free non-clarified fermented beverage or concentrate comprises:
(a) at least one liquid-solid separation device to separate a non-clarified fermented beverage feed comprising alcohol into a first permeate comprising a clarified fermented beverage comprising alcohol and a first retentate comprising solids present in the non-clarified fermented beverage;
(b) a hot pasteurization device, wherein at least a portion of the first retentate is introduced and subjected to a temperature for a time necessary to kill microorganisms to produce a pasteurized solid;
(c) at least one reverse osmosis (RO) device, wherein the clarified fermented beverage comprising alcohol is introduced thereto to separate a RO permeate fraction comprising water and alcohol from a RO retentate fraction comprising retained flavor and color compounds;
(d) at least one microorganism reduction device to remove microorganisms from the RO retentate fraction to produce a liquid that is sterile or otherwise has a substantially reduced bioburden, wherein the sterile liquid is the substantially solids-free fraction comprising retained flavor and color compounds;
(e) optionally an alcohol and water separation device, to separate the RO permeate fraction into a water fraction and an alcohol fraction;
(f) a source of water, wherein the source of water comprises the water fraction from the alcohol and water separation device and/or water from an alternative source, and wherein the source of water is available for diafiltration at the at least one liquid-solid separation device, diafiltration at the at least one RO device and/or for final formulation; and
(g) a final formulator for (A) combining (i) the sterile liquid, (ii) some, or all, of the pasteurized solid, and (iii) optionally with additional water, to produce a non-clarified fermented beverage concentrate, or (B) combining (i) the sterile liquid, (ii) some, or all, of the pasteurized solid, (iii) water and (iv) optionally carbon dioxide to produce an alcohol-reduced or alcohol-free non-clarified fermented beverage.

In a second aspect, a method of processing a fermented beverage to produce an alcohol-reduced or alcohol-free fermented beverage or concentrate is described, said method comprising:
(a) separating a clarified fermented beverage feed comprising alcohol into a second permeate comprising water and alcohol and a second retentate comprising retained flavors and color compounds present in the clarified fermented beverage feed;
(b) reducing the microorganism count of the second retentate to produce a liquid that is sterile or otherwise has a substantially reduced bioburden, wherein the sterile liquid is the substantially solids-free fraction comprising retained flavor and color compounds; and
(c) optionally, formulating the alcohol-reduced or alcohol-free clarified fermented beverage by combining at least the sterile liquid with water and optionally carbon dioxide.

In some embodiments of the second aspect, the method of processing a clarified fermented beverage to produce an alcohol-reduced or alcohol-free clarified fermented beverage or concentrate comprises:
(a) separating a clarified fermented beverage feed comprising alcohol into a second permeate comprising water and alcohol and a second retentate comprising retained flavors and color compounds present in the clarified fermented beverage feed;
(b) reducing the microorganism count of the second retentate to produce a liquid that is sterile or otherwise has a substantially reduced bioburden, wherein the sterile liquid is the substantially solids-free fraction comprising retained flavor and color compounds; and
(c) optionally, formulating the alcohol-reduced or alcohol-free clarified fermented beverage by combining at least the sterile liquid with water and optionally carbon dioxide.

In some embodiments of the second aspect, the method of processing a non-clarified fermented beverage to produce an alcohol-reduced or alcohol-free clarified fermented beverage or concentrate comprises:
(a) separating a non-clarified fermented beverage feed comprising alcohol into a first permeate comprising a clarified fermented beverage comprising alcohol and a first retentate comprising solids present in the non-clarified fermented beverage;
(b) heating at least a portion of the first retentate at a temperature and for a time necessary to kill microorganisms to produce a pasteurized solid;
(c) separating the clarified fermented beverage comprising alcohol into a second permeate comprising water and alcohol and a second retentate comprising retained flavors and color compounds;
(d) reducing the microorganism count of the second retentate to produce a liquid that is sterile or otherwise has a substantially reduced bioburden, wherein the sterile liquid is the substantially solids-free fraction comprising retained flavor and color compounds; and
(c) formulating (A) the alcohol-reduced or alcohol-free non-clarified fermented beverage by combining at least the (i) sterile liquid, (ii) some, or all, of the pasteurized solid, (iii) water and (iv) optionally carbon dioxide, or (B) an alcohol-reduced or alcohol-free non-clarified fermented beverage concentrate by combining the (i) sterile liquid, (ii) some, or all, of the sterile solid, and (iii) optionally additional water.

In some embodiments, regardless of the system or method described herein, the RO retentate stream is not subjected to temperatures greater than about 30° C., and as such the retained flavor and color compounds are not destroyed by the high temperatures used in the prior art. In some embodiments, regardless of the system or method described herein, the RO retentate stream is not subjected to temperatures greater than about 25° C., and as such the retained flavor and color compounds are not destroyed by the high temperatures used in the prior art. In some embodiments, regardless of the system or method described herein, the RO retentate stream is not subjected to temperatures greater than about 20° C., and as such the retained flavor and color compounds are not destroyed by the high temperatures used in the prior art. In some embodiments, regardless of the system or method described herein, the RO retentate stream is not subjected to temperatures greater than about 15° C., and as such the retained flavor and color compounds are not destroyed by the high temperatures used in the prior art.

The system and method of using same described herein can be practiced continuously or in batches, as readily understood by the person skilled in the art. For example, for each individual device of the system described herein, e.g., cross-flow filtration device, reverse osmosis device, etc., one or more additional and identical devices may be arranged in parallel, which permits the central automation system to clean one system while the other systems remain operational, ensuring continuous processing.

The advantages of the present method/system described herein are numerous including, but not limited to, and in no particular order:
the ability to consistently engineer a preferred non-clarified fermented beverage by adjusting the amount of pasteurized solids added to the sterile liquid at final formulation, whether in the concentrated form or for immediate formulation as a consumable non-clarified fermented beverage to be bottled. Advantageously, this adjustment can be done before heat pasteurization so only the fraction of stage 1 retentate that is needed is pasteurized;
because of the use of microorganism reduction devices (i.e., sterile filters, a bioburden reduction filters, or both) and optionally pasteurization (for the solids from non-clarified fermented beverages), the shelf-life of the fermented beverage can be maintained, even though the alcohol has been removed, without having to add preservatives thereto;
the method and system can be integrated and controlled by central automation in a single unit system;
the method can be substantially waste free since the removed alcohol can be repurposed elsewhere;
the system/method can be adjusted and applied to any fermented beverage;
components can be added to the final fermented beverage as desired by consumers including, but not limited to, lime juice, salt, clamato juice, fruit flavors, cannabidiol (CBD), tetrahydrocannabinol (THC), etc.;
the fermented beverage processed using the system and method described herein is preferably substantially devoid of undesired bacteria and other microorganisms because of the sterile filtration or bioburden reduction of the liquid (and heat pasteurization of the solid in the non-clarified embodiment), enabling shelf-life maintenance, as well as permitting the decrease or removal of refrigeration requirements without a significant loss of quality;
the fermented beverage processes described herein do not involve the use of heat to drive off the ethanol from the unseparated or unprocessed fermented beverage thereby retaining better flavor, aroma and mouthfeel, relative to alcohol-reduced or alcohol-free fermented beverages of the prior art. Notably, heat can be used to separate the RO permeate into ethanol and water, but because all of the sugars, flavors and mouthfeel components are present in the RO retentate, the heat cannot destroy the flavor of the final formulation. In other words, the RO retentate comprising the sugars, flavors and mouthfeel components is not heated to temperatures above about 30° C.;
because the RO retentate comprises the flavor and aroma components, which are not subjected to heat pasteurization, the fermented beverage can substantially maintain its original flavor and aroma;
the packaging of a concentrate is described herein, which has multiple advantages including, but not limited to, reduced shipping costs, volumes and weight; reduced storage space required for the concentrate; reduced refrigeration requirements because of the sterility of the concentrate; an increased ability to ship interstate due to the reduced amount of alcohol in the concentrate (e.g., less than 0.5% alcohol); and the ability to use in fermented beverage reconstitution devices anywhere in the world wherein a fermented beverage, whether a reduced-alcohol or non-alcoholic fermented beverage, or a fermented beverage comprising alcohol that is readded to the concentrate at a variety of alcohol percentages, can be prepared for immediate enjoyment;
the reduced-alcohol or non-alcoholic fermented beverage will have substantially the same chemical profile (e.g., when running the fermented beverage through a mass spectrometer) as the unprocessed reduced-alcohol or non-alcoholic fermented beverage, with the exception that most, or all, of the ethanol will have been removed. This is unique relative to reduced-alcohol or non-alcoholic fermented beverages of the prior art, which either have been fermented differently to reduce the amount of ethanol produced, and hence comprise larger quantities of undesirable compounds which were not converted because there is not enough ethanol, or have been heated to drive off the ethanol while simultaneously damaging or destroying some of the heat-sensitive compounds that provide the flavor, aroma and mouthfeel of the unprocessed reduced-alcohol or non-alcoholic fermented beverage.

### Cross-Flow Filtration Devices

For the purposes of the present disclosure, cross-flow filtration devices include, for example, those as manufactured by Smartflow Technologies, Inc., Sanford, NC. USA and variously described in the following United States patents: U.S. Pat. Nos. 4,867,876; 4,882,050; 5,034,124; 5,034,124; 5,049,268; 5,232,589; 5,342,517; 5,593,580; 5,868,930; 10,987,631; 11,654,397; and U.S. patent application Ser. No. 18/315,711 filed on May 11, 2023 in the name of Todd Benson, et al., and entitled “Filter Cassette Article, and Filter Comprising Same”: the disclosures of all of which are hereby incorporated herein by reference in their respective entireties. An embodiment of a cross-flow filtration device is further described hereinbelow.

Briefly, a generalized embodiment of a cross-flow filtration cassette is shown in FIG. 3, said filtration cassette comprising at least one assembly, wherein the at least one assembly comprises a multilaminate array of sheet members of generally rectangular and generally planar shape with main top and bottom surfaces and a first end and a second end along the longitudinal axis, wherein the sheet members include in sequence in said array a first assembly end plate (not shown), a first retentate sheet (10), a first filter sheet (20), a permeate sheet (30), a second filter sheet (20), a second retentate sheet (10), and a second assembly end plate (not shown), wherein each of the assembly end plate, permeate sheet members, and filter sheet members in said array have at least one retentate cutout opening (9) at a first end thereof, and at least one retentate cutout opening (12) at opposite second end thereof, with permeate passage openings (13) at longitudinal side margin portions of the sheet members. Each of the first and second retentate sheets (10) have at least one channel opening (8) therein, extending longitudinally between the first end retentate (9) and second end retentate (12) openings of the permeate and filter sheets in the array. The sheets are bonded (e.g., compression, adhesive, or both) to adjacent sheets about peripheral end and side portions thereof, with their retentate cutout openings and permeate passage openings in register with one another, wherein a central portion of each of the sheets is unbonded to permit liquid source material to flow down the channel opening(s) such that permeate flows through the filter sheet (20) to the permeate sheet (30), and to permit the permeate in the permeate sheet (30) to flow towards the permeate passage openings to the permeate outlet. For case of disclosure, the first end retentate (9) and second end retentate openings (12) (and permeate passage openings (13)) are illustrated in FIG. 3 as generally rectangular or square but can be an irregular pentagon. It should be appreciated by the person skilled in the art that the shape of the retentate openings (and permeate passage openings) are not limited to rectangles or squares or irregular pentagons and can include any other reasonable shape for the flow of fluid therethrough, as readily understood by the person skilled in the art. Two assembly end plates sandwich the multilaminate array of sheets, wherein the two assembly end plates comprise at least one fluid opening at the first end thereof, and at least one fluid opening at the second end thereof, or both, in register with the fluid openings of the array. In addition, the at least one assembly can further comprise at least one of options (I), (II), (III), or (IV), or any combination of (I)-(IV): (I) a cap positioned on at least a portion of the first end fluid opening(s) or at least a portion of the second end fluid opening(s), or both, of a permeate pack, wherein the permeate pack comprises the first filter sheet, the permeate sheet, and the second filter sheet members, wherein the cap is positioned proximate to the channel openings of the first and second retentate sheets; (II) the fluid openings at the first end, the fluid openings at the second end, or both the fluid openings at the first and second end, are cut as an irregular pentagon having a “V” positioned proximate to the channel openings of the first and second retentate sheets; (III) a first permeate screen spacer positioned between the first filter sheet and the permeate sheet or a second permeate screen spacer positioned between the second filter sheet and the permeate sheet, or both, wherein the permeate screen spacer(s) comprise fluid openings in register with the fluid openings of the array; (IV) the permeate sheet comprises a metal matrix or other reinforced porous material of requisite thickness.

The cross-flow filtration cassettes can be mounted between holder plates, which may be provided with suitable ports, for introduction of liquid source material to be separated in the cassettes, and for discharge or withdrawal of filtrate/permeate and retentate (see, e.g., FIG. 4). One skilled in the art can appreciate that the assembly end plates can be integrally sealed to the assembly of sheets to have a single module comprised of assembly end plates and at least one assembly of sheets. If the integrally sealed assembly end plates are of plastic or polymeric materials or sheets, the units may provide the function of a disposable device for single or multiple use.

In the use of cross-flow filtration cassettes, the specificity and speed of a desired separation is effected by a number of factors including, but not limited to, a) fluid distribution in the cross-flow module, b) channel height of the cross-flow module, c) channel length, d) shear rate, e) sheet pore structure, f) sheet structure, g) sheet chemistry, h) trans-membrane pressure, i) osmotic force, j) hydrophobic/hydrophilic differential, k) liquid source material modification, l) temperature, and m) pressure drop, which is a function of applied pressure channel length, velocity and solution viscosity.

For use in the present apparatus and method, the pore size of the filter sheets are selected to ensure that the specific targeted material, e.g., fine pulp, do not pass through the filter sheets during filtration, i.e., do not pass through the filter sheet and enter the permeate stream, as readily determined by the person skilled in the art. The pore size can also be selected to isolate species such as enzymes from solids, e.g., fine pulp, as understood by the person skilled in the art.

It is well known in the art that there can be benefits to working with a higher temperature fluid because the viscosity of the fluid can decrease as the temperature increases. As a result, the permeate flux passage is improved with a concomitant decrease in the energy expenditure and processing costs. Further, smaller capacity pumps can be used and heat exchangers and buffer tanks can be eliminated. Another advantage is the ability to achieve a higher percentage solids target at a higher temperature relative to that achieved at the lower temperatures of the prior art. Towards that end, the assembly end plates, the filter sheets, the retentate sheets, and permeate sheets (and the optional permeate screen spacer sheets) are made of materials which are adapted to accommodate high temperatures, so that the interior surfaces of the filtration cassette are able to withstand higher processing temperature and/or extreme pH and may be steam sterilized and/or chemically sanitized solutions for regeneration and reuse, as “steam-in-place” and/or “sterilizable in situ” structures, respectively. In one embodiment, liquid source materials having temperatures in a range from about 1° C. to about 130° C. can be introduced into the cross-flow filter cassettes. Other temperature ranges contemplated include about 1° C. to about 37° C., about 10° C. to about 30° C., greater than 10° C. to about 25° C., and greater than 10° C. to about 20° C. Alternatively, the entire cassette may be formed of materials which render the cassette disposable in character.

In some embodiments, a cross-flow filtration cassette for use in the methods and systems described herein comprises at least one assembly, wherein the at least one assembly comprises:
a multilaminate array of sheet members of generally rectangular and generally planar shape, each sheet of the array having a first end, a second end longitudinally opposite the first end, and a thickness, wherein the sheet members comprise in sequence in said array, a first retentate sheet, (a permeate pack and a second retentate sheet) n, wherein n=1, 2, 3, 4, 5, 6, 7, 8, 9, 10, or more, wherein the permeate pack comprises a first filter sheet, a permeate sheet, and a second filter sheet, wherein each sheet in each permeate pack has at least one fluid opening at the first end thereof and at least one fluid opening at the second end thereof, wherein corresponding fluid openings at the first end of each sheet in each permeate pack are in register with one another and corresponding fluid openings at the second end of each sheet in each permeate pack are in register with one another, wherein the first and second retentate sheets have at least one channel opening therein, each channel opening extending longitudinally between a first channel entrance positioned proximate to fluid openings at the first end of the permeate pack and a second channel entrance positioned proximate to fluid openings at the second end of the permeate pack in the array, and wherein the at least one channel opening is open through the entire thickness of the first and second retentate sheets to permit a fluid to contact adjacent filter sheets, and wherein the first and second retentate sheets are bonded to adjacent filter sheets about peripheral end and side portions thereof; and
two assembly end plates sandwiching the multilaminate array of sheets, each end plate having a first end and a second end corresponding to that of the multilaminate array of sheets, wherein the two assembly end plates comprise at least one fluid opening at the first end thereof and at least one fluid opening at the second end thereof, wherein fluid openings of the end plates are in register with corresponding fluid openings of the permeate pack.
wherein the at least one assembly further comprises at least one permeate passage opening at longitudinal side margin portions of the sheet members of the assembly,
   wherein the filtration cassette further comprises a cap positioned on at least a portion of at least one fluid opening of the permeate pack, wherein the cap is positioned proximate to channel entrances of the first and second retentate sheets, and wherein the cap has a general U-shape and transverses the permeate pack through the fluid opening and at least partially overlaps a first side of the first filter sheet and at least partially overlaps a second side of the second filter sheet, with the permeate sheet positioned therebetween.

In some embodiments, a filtration cassette for use in the methods and systems described herein comprises at least one assembly, wherein the at least one assembly comprises:
a multilaminate array of sheet members of generally rectangular and generally planar shape, each sheet of the array having a first end, a second end longitudinally opposite the first end, and a thickness, wherein the sheet members comprise in sequence in said array, a first retentate sheet, (a permeate pack and a second retentate sheet) n, wherein n=1, 2, 3, 4, 5, 6, 7, 8, 9, 10, or more, wherein the permeate pack comprises a first filter sheet, a permeate sheet, and a second filter sheet, wherein each sheet in each permeate pack has at least one fluid opening at the first end thereof and at least one fluid opening at the second end thereof, wherein corresponding fluid openings at the first end of each sheet in each permeate pack are in register with one another and corresponding fluid openings at the second end of each sheet in each permeate pack are in register with one another, wherein the first and second retentate sheets have at least one channel opening therein, each channel opening extending longitudinally between a first channel entrance positioned proximate to fluid openings at the first end of the permeate pack and a second channel entrance positioned proximate to fluid openings at the second end of the permeate pack in the array, and wherein the at least one channel opening is open through the entire thickness of the first and second retentate sheets to permit a fluid to contact adjacent filter sheets, and wherein the first and second retentate sheets are bonded to adjacent filter sheets about peripheral end and side portions thereof; and
two assembly end plates sandwiching the multilaminate array of sheets, each end plate having a first end and a second end corresponding to that of the multilaminate array of sheets, wherein the two assembly end plates comprise at least one fluid opening at the first end thereof and at least one fluid opening at the second end thereof, wherein fluid openings of the end plates are in register with corresponding fluid openings of the permeate pack.
wherein the at least one assembly further comprises at least one permeate passage opening at longitudinal side margin portions of the sheet members of the assembly,
   wherein the permeate sheet comprises a metal matrix or other reinforced porous material of requisite thickness, wherein a width of the permeate passage opening of the permeate sheet is less than a width of the permeate passage opening of each of the filter sheets and retentate sheets in the multilaminate array of sheets.

The system and method described herein can comprise the cross-flow filtration cassette devices described herein, which enables control of the separation size and washing of the solids. The use of the cross-flow filtration cassette devices can be optimized to maximize passage of the aroma and flavor species of the non-clarified fermented beverage into the respective permeate. Advantageously, the cross-flow filtration cassette devices described herein can be constructed to withstand high clean-in-place temperatures and comprise open channels which enables ready cleanability at typical intervals. Moreover, the cross-flow filtration cassette devices described herein prevent occlusion of the membrane and have less torturous pathways for passage of the solid phase of the non-clarified fermented beverage.

### Computer Programs

The present subject matter is described as a system, and a method of using same, but also can be a computer program product. In some embodiments, the computer program product may include a computer readable storage medium (or media) having computer readable program instructions thereon for causing a processor to carry out the systems or methods described herein.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the systems and methods described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform systems and methods described herein.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Accordingly, in a third aspect, a non-transitory computer-readable storage medium is described, which stores a computer program thereon which, when run in a computer, causes the computer to carry out the steps of the systems and methods described herein.

### CLAUSES

Clause 1. A system for processing a clarified fermented beverage to an alcohol-reduced or alcohol-free clarified fermented beverage or concentrate, said system comprising:
(a) at least one reverse osmosis (RO) device, wherein a clarified fermented beverage feed comprising alcohol is introduced thereto to separate a RO permeate fraction comprising water and alcohol from a RO retentate fraction comprising retained flavor and color compounds present in the clarified fermented beverage feed;
(b) at least one microorganism reduction device to remove microorganisms from the RO retentate fraction to produce a liquid that is sterile or otherwise has a substantially reduced bioburden, wherein the sterile liquid is a substantially solids-free fraction comprising retained flavor and color compounds;
(c) optionally an alcohol and water separation device, to separate the RO permeate fraction into a water fraction and an alcohol fraction;
(d) a source of water, wherein the source of water comprises the water fraction from the alcohol and water separation device and/or water from an alternative source, and wherein the source of water is available for diafiltration at the at least one RO device and/or for final formulation; and
(e) optionally; a final formulator for combining the sterile liquid with water and optionally carbon dioxide to produce an alcohol-reduced or alcohol-free clarified fermented beverage.

Clause 2. A system for processing a non-clarified fermented beverage to an alcohol-reduced or alcohol-free non-clarified fermented beverage or concentrate, said system comprising:
(a) at least one liquid-solid separation device to separate a non-clarified fermented beverage feed comprising alcohol into a first permeate comprising a clarified fermented beverage comprising alcohol and a first retentate comprising solids present in the non-clarified fermented beverage;
(b) a hot pasteurization device, wherein at least a portion of the first retentate is introduced and subjected to a temperature for a time necessary to kill microorganisms to produce a pasteurized solid;
(c) at least one reverse osmosis (RO) device, wherein the clarified fermented beverage comprising alcohol is introduced thereto to separate a RO permeate fraction comprising water and alcohol from a RO retentate fraction comprising retained flavor and color compounds;
(d) at least one microorganism reduction device to remove microorganisms from the RO retentate fraction to produce a liquid that is sterile or otherwise has a substantially reduced bioburden, wherein the sterile liquid is the substantially solids-free fraction comprising retained flavor and color compounds;
(e) optionally an alcohol and water separation device, to separate the RO permeate fraction into a water fraction and an alcohol fraction;
(f) a source of water, wherein the source of water comprises the water fraction from the alcohol and water separation device and/or water from an alternative source, and wherein the source of water is available for diafiltration at the at least one liquid-solid separation device, diafiltration at the at least one RO device and/or for final formulation; and
(g) a final formulator for (A) combining (i) the sterile liquid, (ii) some, or all, of the pasteurized solid, and (iii) optionally with additional water, to produce a non-clarified fermented beverage concentrate, or (B) combining (i) the sterile liquid, (ii) some, or all, of the pasteurized solid, (iii) water and (iv) optionally carbon dioxide to produce an alcohol-reduced or alcohol-free non-clarified fermented beverage.

Clause 3. The system of clause 2, wherein the at least one liquid-solid separation device comprises at least one of dead-end filtration, centrifugation, tangential cross-flow filtration, and reverse osmosis, preferably at least one cross-flow filtration device.

Clause 4. The system of any of clauses 1-3, wherein the at least one microorganism reduction device comprises a sterile filter, a bioburden reduction filter, or both a bioburden reduction filter and a sterile filter.

Clause 5. The system of any of clauses 1-4, wherein the at least one microorganism reduction device never achieves a temperature greater than 30° C., preferably not greater than 20° C.

Clause 6. The system of any of clauses 1-5, wherein the alcohol and water separation device is a distillation device.

Clause 7. A method of processing a clarified fermented beverage to produce an alcohol-reduced or alcohol-free clarified fermented beverage or concentrate, said method comprising:
(a) separating a clarified fermented beverage feed comprising alcohol into a second permeate comprising water and alcohol and a second retentate comprising retained flavors and color compounds present in the clarified fermented beverage feed;
(b) reducing the microorganism count of the second retentate to produce a liquid that is sterile or otherwise has a substantially reduced bioburden, wherein the sterile liquid is the substantially solids-free fraction comprising retained flavor and color compounds; and
(c) optionally; formulating the alcohol-reduced or alcohol-free clarified fermented beverage by combining at least the sterile liquid with water and optionally carbon dioxide.

Clause 8. A method of processing a non-clarified fermented beverage to produce an alcohol-reduced or alcohol-free clarified fermented beverage or concentrate, said method comprising:
(a) separating a non-clarified fermented beverage feed comprising alcohol into a first permeate comprising a clarified fermented beverage comprising alcohol and a first retentate comprising solids present in the non-clarified fermented beverage;
(b) heating at least a portion of the first retentate at a temperature and for a time necessary to kill microorganisms to produce a pasteurized solid;
(c) separating the clarified fermented beverage comprising alcohol into a second permeate comprising water and alcohol and a second retentate comprising retained flavors and color compounds;
(d) reducing the microorganism count of the second retentate to produce a liquid that is sterile or otherwise has a substantially reduced bioburden, wherein the sterile liquid is the substantially solids-free fraction comprising retained flavor and color compounds; and
(e) formulating (A) the alcohol-reduced or alcohol-free non-clarified fermented beverage by combining at least the (i) sterile liquid, (ii) some, or all, of the pasteurized solid, (iii) water and (iv) optionally carbon dioxide, or (B) an alcohol-reduced or alcohol-free non-clarified fermented beverage concentrate by combining the (i) sterile liquid, (ii) some, or all, of the sterile solid, and (iii) optionally additional water.

Clause 9. The method of clause 8, wherein the non-clarified fermented beverage feed is separated into the first permeate and the first retentate using at least one liquid-solid separation device.

Clause 10. The method of clause 9, wherein the at least one liquid-solid separation device comprises at least one of dead-end filtration, centrifugation, tangential cross-flow filtration, and reverse osmosis, preferably at least one cross-flow filtration device.

Clause 11. The method of any of clauses 7-10, further comprising separating the RO permeate fraction into a water fraction and an alcohol fraction.

Clause 12. The method of clause 11, wherein the separation is effectuated using an alcohol and water separation device.

Clause 13. The method of clause 12, wherein the alcohol and water separation device is a distillation device.

Clause 14. The method of any of clauses 11-13, wherein the water fraction is available for diafiltration and/or for final formulation.

Clause 15. The method of any of clauses 7-14, wherein the separation of the clarified fermented beverage into the second permeate and the second retentate is done using at least one reverse osmosis (RO) device.

Clause 16. The method of any of clauses 7-15, wherein the microorganism count is reduced using at least one microorganism reduction device.

Clause 17. The method of clause 16, wherein the at least one microorganism reduction device comprises a sterile filter, a bioburden reduction filter, or both a bioburden reduction filter and a sterile filter.

Clause 18. The method of clauses 16 or 17, wherein the at least one microorganism reduction device never achieves a temperature greater than 30° C., preferably not greater than 20° C.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

What is claimed is:

1. A system for processing a fermented beverage to an alcohol-reduced or alcohol-free fermented beverage or concentrate, said system comprising:
(a) at least one reverse osmosis (RO) device, wherein a clarified fermented beverage feed comprising alcohol is introduced thereto to separate a RO permeate fraction comprising water and alcohol from a RO retentate fraction comprising retained flavor and color compounds present in the clarified fermented beverage feed;
(b) at least one microorganism reduction device to remove microorganisms from the RO retentate fraction to produce a liquid that is sterile or otherwise has a substantially reduced bioburden, wherein the sterile liquid is a substantially solids-free fraction comprising retained flavor and color compounds;
(c) optionally an alcohol and water separation device, to separate the RO permeate fraction into a water fraction and an alcohol fraction;
(d) a source of water, wherein the source of water comprises the water fraction from the alcohol and water separation device and/or water from an alternative source, and wherein the source of water is available for diafiltration at the at least one RO device and/or for final formulation; and
(e) optionally, a final formulator for combining the sterile liquid with water and optionally carbon dioxide to produce an alcohol-reduced or alcohol-free fermented beverage.

2. The system of claim 1, further comprising at least one liquid-solid separation device to separate a non-clarified fermented beverage feed comprising alcohol into a first permeate comprising a clarified fermented beverage comprising alcohol and a first retentate comprising solids present in the non-clarified fermented beverage.

3. The system of claim 2, further comprising a hot pasteurization device, wherein at least a portion of the first retentate is introduced and subjected to a temperature for a time necessary to kill microorganisms to produce a pasteurized solid.

4. The system of claim 2, wherein the source of water is available for diafiltration at the at least one liquid-solid separation device.

5. The system of claim 3, wherein the final formulator (A) combines (i) the sterile liquid, (ii) some, or all, of the pasteurized solid, and (iii) optionally additional water, to produce a non-clarified fermented beverage concentrate, or (B) combining (i) the sterile liquid, (ii) some, or all, of the pasteurized solid, (iii) water and (iv) optionally carbon dioxide to produce an alcohol-reduced or alcohol-free non-clarified fermented beverage.

6. The system of claim 2, wherein the at least one liquid-solid separation device comprises at least one of dead-end filtration, centrifugation, tangential cross-flow filtration, and reverse osmosis, preferably at least one cross-flow filtration device.

7. The system of claim 1, wherein the at least one microorganism reduction device comprises a sterile filter, a bioburden reduction filter, or both a bioburden reduction filter and a sterile filter.

8. The system of claim 1, wherein the at least one microorganism reduction device never achieves a temperature greater than 30° C.

9. The system of claim 1, wherein the alcohol and water separation device is a distillation device.

10. A method of processing a fermented beverage to produce an alcohol-reduced or alcohol-free fermented beverage or concentrate, said method comprising:
(a) separating a clarified fermented beverage feed comprising alcohol into a second permeate comprising water and alcohol and a second retentate comprising retained flavors and color compounds present in the clarified fermented beverage feed;
(b) reducing the microorganism count of the second retentate to produce a liquid that is sterile or otherwise has a substantially reduced bioburden, wherein the sterile liquid is the substantially solids-free fraction comprising retained flavor and color compounds; and
(c) optionally, formulating the alcohol-reduced or alcohol-free clarified fermented beverage by combining at least the sterile liquid with water and optionally carbon dioxide.

11. The method of claim 10, further comprising separating a non-clarified fermented beverage feed comprising alcohol into a first permeate comprising a clarified fermented beverage comprising alcohol and a first retentate comprising solids present in the non-clarified fermented beverage.

12. The method of claim 11, further comprising heating at least a portion of the first retentate at a temperature and for a time necessary to kill microorganisms to produce a pasteurized solid.

13. The method of claim 12, further comprising formulating (A) the alcohol-reduced or alcohol-free non-clarified fermented beverage by combining at least the (i) sterile liquid, (ii) some, or all, of the pasteurized solid, (iii) water and (iv) optionally carbon dioxide, or (B) an alcohol-reduced or alcohol-free non-clarified fermented beverage concentrate by combining the (i) sterile liquid, (ii) some, or all, of the sterile solid, and (iii) optionally additional water.

14. The method of claim 11, wherein the non-clarified fermented beverage feed is separated into the first permeate and the first retentate using at least one liquid-solid separation device.

15. The method of claim 14, wherein the at least one liquid-solid separation device comprises at least one of dead-end filtration, centrifugation, tangential cross-flow filtration, and reverse osmosis, preferably at least one cross-flow filtration device.

16. The method of claim 10, further comprising separating the RO permeate fraction into a water fraction and an alcohol fraction.

17. The method of claim 10, wherein the water fraction is available for diafiltration and/or for final formulation.

18. The method of claim 10, wherein the separation of the clarified fermented beverage into the second permeate and the second retentate is done using at least one reverse osmosis (RO) device.

19. The method of claim 10, wherein the microorganism count is reduced using at least one microorganism reduction device selected from a sterile filter, a bioburden reduction filter, or both a bioburden reduction filter and a sterile filter.

20. The method of claim 19, wherein the at least one microorganism reduction device never achieves a temperature greater than 30° C.
